(19) United States
(12) Patent Application Publication
(10) Pub. No.: US 2018/0237671 A1
(43) Pub. Date: Aug. 23, 2018

(54) OILY CHEMICAL RESISTANT MOISTURE CURABLE HOT MELT ADHESIVE COMPOSITIONS AND ARTICLES INCLUDING THE SAME

(71) Applicant: H.B. Fuller Company, St. Paul, MN (US)

(72) Inventors: Sudipto Das, St. Paul, MN (US); Henry P. Meyer, Stillwater, MN (US)

(21) Appl. No.: 15/553,500

(22) PCT Filed: Feb. 26, 2016
(86) PCT No.: PCT/US2016/019885

§ 371 Date: Aug. 24, 2017

Related U.S. Application Data
(60) Provisional application No. 62/126,034, filed on Feb. 27, 2015.

(51) Int. Cl. C09J 175/06; B32B 7/12

(52) U.S. Cl. CPC C09J 175/06; C08G 18/12; C08G 2170/20; B32B 7/12

(57) ABSTRACT

Disclosed is a moisture curable hot melt adhesive composition that includes a polyurethane prepolymer that includes the reaction product of an amorphous polyester polyol having a solubility parameter of at least 9.8 (cal/cm³)^{1/2} and a glass transition temperature no greater than 25° C., at least 10% by weight of a crystalline polyester polyol having a melting point of at least 75° C., and polyisocyanate.

### CROSS REFERENCE TO RELATED APPLICATION

This application is a 371 application of PCT International Application No. PCT/US2016/019885, filed with the United States Receiving Office on Feb. 26, 2016, and incorporated herein, and claims the benefit of U.S. Provisional Application No. 62/126,034, filed on Feb. 27, 2015, and incorporated herein.

### BACKGROUND

The invention is directed to maintaining adhesion upon exposure to an oily substance.

Adhesive compositions are used in a variety of applications, some of which may result in the adhesive coming into contact with oil or a composition that includes oil. The presence of oil at an adhesive bond can decrease the strength of the adhesive bond and may cause the adhesive bond to fail.

Some components of electronic devices are bonded together through adhesive compositions. Electronic devices may come into contact with the skin and sweat of users during use, e.g., when held in the hand of the user or when worn on the body. The skin may have natural oils or may include added oils such as suntan lotion and suntan oil. If oil transfers from the user to the electronic device and contacts an adhesive, the adhesive bond may fail either cohesively or adhesively.

It would be desirable to achieve an adhesive composition that maintains bond strength to a variety of substrates when exposed to a variety of compositions that include oil such as suntan lotions, suntan oils, and oils present on the skin of an individual.

### SUMMARY

In one aspect, the invention features a moisture curable polyurethane hot melt adhesive composition that includes a polyurethane prepolymer that includes the reaction product of an amorphous polyester polyol having a solubility parameter of at least 9.8 (calories per cubic centimeter)^{1/2} ((cal/cm³)^{1/2}) and a glass transition temperature (T_{g}) of no greater than 25° C., at least 10% by weight of a crystalline polyester polyol having a melting point of at least 75° C., from 0% by weight to no greater than 10% by weight of a crystalline polyester polyol having a melting point of less than 70° C., and polyisocyanate.

In another aspect, the invention features a moisture curable polyurethane hot melt adhesive composition that includes a polyurethane prepolymer comprising the reaction product of an amorphous polyester polyol having a solubility parameter of at least 9.8 (cal/cm³)^{1/2}, and a T_{g} of no greater than 25° C., at least 20% by weight of a crystalline polyester polyol having a melting point of at least 75° C. and a number average molecular weight from about 1000 grams per mole (g/mol) to no greater than 20,000 g/mol, and polyisocyanate.

In other aspects, the invention features a moisture curable polyurethane hot melt adhesive composition that includes a polyurethane prepolymer that includes the reaction product of an amorphous polyester polyol having a solubility parameter of at least 9.8 (cal/cm³)^{1/2}, and a T_{g} of no greater than 25° C., at least 10% by weight of a crystalline polyester polyol having a melting point of at least 75° C., and polyisocyanate, the composition exhibiting at least 30% retention of bond strength to stainless steel when tested according to the Method of Determining Percentage of Retention of Bond Strength to Stainless Steel.

In one embodiment, the amorphous polyester polyol includes hexanediol phthalate polyester diol. In another embodiment, the crystalline polyester polyol has a melting point of at least 75° C. comprises ethylene glycol dodecanoate polyester polyol, cyclohexanedimethanol adipate polyester polyol, butanediol succinate polyester polyol, or a combination thereof.

In some embodiments, the amorphous polyester polyol has a solubility parameter of at least 10.0 (cal/cm³)^{1/2}. In other embodiments, the amorphous polyester polyol has a solubility parameter of at least 10.2 (cal/cm³)^{1/2}.

In one embodiment, the crystalline polyester polyol has a melting point of at least 75° C. and comprises at least two different crystalline polyester polyols each having a melting point of at least 75° C. In some embodiments, the melting point of one of the at least two different crystalline polyester polyols is greater than the melting point of another of the at least two different crystalline polyester polyols.

In another embodiment, the polyurethane prepolymer includes the reaction product of at least 20% by weight of the amorphous polyester polyol and at least 15% by weight crystalline polyester polyol having a melting point of at least 75° C. In other embodiments, the polyurethane prepolymer includes the reaction product of at least 40% by weight of the amorphous polyester polyol and at least 15% by weight crystalline polyester polyol having a melting point of at least 75° C.

In some embodiments, the amorphous polyester polyol has a T_{g} of no greater than 20° C. In other embodiments, the amorphous polyester polyol has a T_{g} of no greater than 0° C.

In another embodiment, the composition exhibits a viscosity of less than 10,000 centipoises at 120° C. In some embodiments, the composition exhibits an open time of at least 50 seconds. In other embodiments, the composition exhibits at least 80 pounds of force (lbf) when tested according to the Polycarbonate to Polycarbonate Oleic Acid Resistance Test Method. In another embodiment, the composition exhibits at least 30 lbf when tested according to the Polycarbonate to Stainless Steel Oleic Acid Resistance Test Method. In one embodiment, the composition exhibits at least 40 lbf when tested according to the Polycarbonate to Stainless Steel Oleic Acid Resistance Test Method.

In one embodiment, the composition exhibits at least 50% a retention of bond strength to polycarbonate. In another embodiment, the composition exhibits at least 30% retention of bond strength to stainless steel.

In other aspects, the invention features an article that includes a first substrate, a moisture cured polyurethane hot melt adhesive composition, and a second substrate bonded to the first substrate through the cured adhesive composition, the cured adhesive composition comprising having been derived from a moisture curable composition disclosed herein. In one embodiment, the article further includes an electrically conductive element. In some embodiments, the electrically conductive element includes metal. In other embodiments, the electrically conductive element includes an electrically conductive polymer.

In some embodiments, the article is a wearable electronic device and when the device is worn by an individual as intended the adhesive composition contacts at least one of the skin of the individual and a fluid emitted by the individual. In some embodiments, the device includes an electronic monitor. In other embodiments, the device includes eye glasses.

In other embodiments, the article is a hand held electronic device and when the device is held by an individual the adhesive composition contacts at least one of the skin of the individual and a fluid emitted by the individual. In another embodiment, the device includes a phone, a tablet, a sound player, a remote control, a mouse, or a combination thereof.

In one embodiment, the first substrate includes at least a portion of a watch band. In some embodiments, the first substrate includes at least a portion of a pump for dispensing medicine. In other embodiments, the first substrate includes at least a portion of a headband.

In other embodiments, the first substrate includes a polymer, polymer composite, metal, fabric, or a combination thereof, and the second substrate comprises polymer, polymer composite, metal, fabric, or a combination thereof. In another embodiment, the first substrate includes fabric, film, or a combination thereof and the second substrate includes fabric, film, or a combination thereof.

In some embodiments, the article further includes a third substrate, the first substrate, the second substrate, and the third substrate being bonded to one another through the cured adhesive composition.

The invention features a moisture curable hot melt adhesive composition that maintains a bond to a substrate when exposed to an oily substance and articles that include the same.

Other features and advantages will be apparent from the following description of the preferred embodiments, the claims, and the drawings, in which like numerals have been used to indicate like features.

### BRIEF DESCRIPTION OF THE DRAWINGS

FIG. 1 is a view taken in cross-section of an example of an article that includes a moisture cured polyurethane hot melt adhesive composition.

FIG. 2 is a view taken in cross-section of an example of an article that includes a conductive element and a moisture cured polyurethane hot melt adhesive composition.

FIG. 3 is a view taken in cross-section of an example of a wearable electronic article.

FIG. 4 is a view taken in cross-section of an example of a handheld electronic device.

FIG. 5 is a plan view of a test specimen for use in the Pounds of Force Test Method.

### GLOSSARY

In reference to the invention, these terms have the meanings set forth below:

The term “crystalline” means having a melt transition when measured using Differential Scanning Calorimetry.

The term “amorphous” means having no melt transition when measured using Differential Scanning Calorimetry.

### DETAILED DESCRIPTION

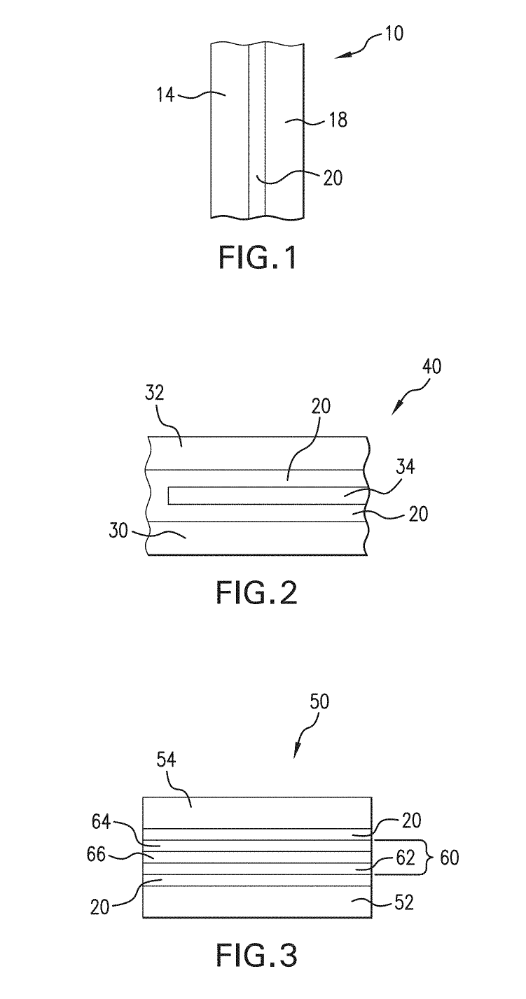

The article 10 includes two substrates 14, 18 bonded together through a moisture cured polyurethane hot melt adhesive composition 20, as shown in FIG. 1. When the article is used or worn by the user, the adhesive composition may come into contact with the individual's skin or a fluid emitted by the individual. Such fluids might include, e.g., oils naturally emitted by the body through the skin (e.g., oleic acid), suntan lotion, suntan oil, and combinations thereof. The adhesive bond of the article preferably withstands exposure to any oily substance present on the skin of the user; more preferably the substrates of the article remain bonded together through the adhesive composition after exposure of a portion of the adhesive composition to the oily substance.

The moisture curable hot melt adhesive composition exhibits a viscosity of less than about 10,000 centipoise (cPs), from about 1000 cPs to about 10,000 cPs, from about 2000 cPs to about 6000 cPs, from about 2000 cPs to about 5000 cPs, or even from about 2000 cPs to about 4000 cPs, at 120° C.

The moisture curable hot melt adhesive composition forms a good adhesive bond to a variety of substrates including, e.g., polycarbonate and metal. Preferably the cured hot melt adhesive composition exhibits a bond strength of at least 70 pounds of force (lbf), at least 80 lbf, at least 90 lbf, or even at least 100 lbf to polycarbonate, or even to stainless steel.

The cured adhesive composition preferably exhibits good resistance to a variety of oily compositions, and preferably maintains an adhesive bond to a substrate after exposure to an oily composition such as suntan lotion, suntan oil, and oleic acid. One useful measure of oil resistance is the Oleic Acid Resistance Test Method. The cured adhesive composition preferably exhibits at least 20 lbf, at least 25 lbf, at least 30 lbf, at least 35 lbf, at least 40 lbf, at least 50 lbf, at least 80 lbf, or even at least 100 lbf when tested according to the Polycarbonate to Polycarbonate Oleic Acid Resistance Test Method or even the Polycarbonate to Stainless Steel Oleic Acid Resistance Test Method.

The cured adhesive composition also preferably exhibits at least 50%, at least 75%, or even at least 100% retention of bond strength to polycarbonate, and at least 20%, at least 30%, at least 50%, or even at least 60% retention of bond strength to stainless steel.

The moisture curable hot melt adhesive composition can exhibit an open time of at least 60 seconds, at least 90 seconds, at least 2 minutes, no greater than 15 minutes, no greater than 10 minutes, no greater than 6 minutes, no greater than about 5 minutes, or even no greater than about 4 minutes.

The moisture cured hot melt polyurethane adhesive composition includes the reaction product of moisture (e.g., ambient moisture, applied moisture, or a combination there) and a moisture curable polyurethane hot melt adhesive composition that includes polyurethane prepolymer and optionally polyisocyanate (e.g., residual polyisocyanate, added polyisocyanate, and combinations thereof). The polyurethane prepolymer includes the reaction product of amorphous polyester polyol, crystalline polyester polyol, and polyisocyanate. The moisture curable polyurethane hot melt adhesive composition and the polyurethane prepolymer preferably are derived from at least 75% by weight, at least 80% by weight, or even at least 85% by weight of a polyester polyol component that consists of amorphous polyester polyol having a glass transition temperature of no greater than 25° C. and a solubility parameter of at least 9.8 (cal/cm³)^{1/2} and a crystalline polyester polyol having a melting point of at least 75° C.

Amorphous Polyester Polyol

The amorphous polyester polyol has a number average molecular weight of from at least 500 g/mol to about 10,000 g/mol, from about 500 g/mole to about 5000 g/mol, or even from about 500 g/mole to about 4000 g/mole, a glass transition temperature (T_{g}) of no greater than 25° C., no greater than 20° C., no greater than 10° C., less than 0° C., no greater than −5° C., no greater than −10° C., no greater than −15° C., or even no greater than −19° C., and exhibits a solubility parameter of at least 9.8 (cal/cm³)^{1/2}, at least 10.0 (cal/cm³)^{1/2}, at least 10.1 (cal/cm³)^{1/2}, or even at least 10.2 (cal/cm³)^{1/2}.

The amorphous polyester polyol includes some aromatic character including, e.g., aromatic groups or units in the backbone of the polyol. Useful amorphous polyester polyols include at least 15% by weight, at least 17% by weight, at least 20% by weight, at least 25% by weight aromatic hydrogen, or even from 0% by weight to 25% by weight aromatic hydrogen (i.e., hydrogen atoms present on aromatic groups or units).

The polyurethane prepolymer optionally is derived from at least two different amorphous polyester polyols, suitable examples of which include at least two amorphous polyester polyols that are compositionally similar but differ in molecular weight, at least two amorphous polyester polyols that are compositionally different but similar in molecular weight, at least two amorphous polyester polyols that are compositionally different and differ in molecular weight, at least two amorphous polyester polyols that differ in solubility parameter, and combinations thereof.

The amorphous polyester polyol includes the reaction product of a polyacid component (e.g., polyacid, polyacid anhydride, polyacid ester and polyacid halide), and a stoichiometric excess of polyol. At least one of the polyacid component and the polyol includes an aromatic group. Suitable polyacids include, e.g., diacids (e.g., dicarboxylic acids), triacids (e.g., tricarboxylic acids), and higher order acids, examples of which include aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid), and combinations thereof.

Examples of suitable polyols include aliphatic polyols, e.g., ethylene glycols, propane diols (e.g., 1,2-propanediol and 1,3-propanediol), butane diols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl-1,8-octanediol, trimethylolpropane, pentaerythritol, sorbitol, glucose, and combinations thereof.

Specific examples of useful amorphous polyester polyols include poly(hexanediol phthalate) polyol, poly(neopentyl glycol phthalate) polyol, poly(neopentyl glycol hexanediol phthalate) polyol, poly(diethylene glycol phthalate) polyol, poly(ethylene glycol adipic acid terephthalate) polyol, polyethylene terephthalate polyols, and combinations thereof.

Useful amorphous polyester polyols are commercially available under a variety of trade designations including, e.g., DYNACOLL 7210, 7230, and 7320 from Evonik Industries AG (Germany), STEPANPOL PH56 and PD56 from Stepan Company (Northfield, Ill.) and PIOTHANE 500 HP, 1000 HP, 3500 EAT, 2000 DP and 2000 HP from Panolam Industries Int'l, Inc. (Auburn, Me.).

The amount of amorphous polyester polyol used to form the polyurethane prepolymer is at least 15% by weight, at least 20% by weight, at least 25% by weight, at least 30% by weight, at least 40% by weight, from 15% by weight to about 70% by weight, from about 25% by weight to about 70% by weight, from about 35% by weight to about 65% by weight, or even from about 40% by weight to about 65% by weight based on the weight of polyurethane prepolymer.

Crystalline Polyester Polyol

The crystalline polyester polyol has a melting point of at least 75° C., at least about 80° C., at least about 85° C., or even from at least 75° C. to about 120° C., or even from 80° C. to 120° C., and a number average molecular weight of no greater than about 20,000 g/mol, no greater than about 10,000 g/mol, at least 1000 g/mol, at least 1500 g/mol, from about 2,000 g/mol to about 20,000 g/mol, from about 2,000 g/mol to about 10,000 g/mol, from about 2,000 g/mol to about 9,000 g/mol, or even from about 2,000 g/mol to about 6,000 g/mol. The crystalline polyester polyol has a glass transition temperature (T_{g}) of no greater than 20° C.

The polyurethane prepolymer optionally is derived from at least two different crystalline polyester polyols, suitable examples of which include at least two crystalline polyester polyols that are compositionally similar but differ in molecular weight, at least two crystalline polyester polyols that are compositionally different but similar in molecular weight, at least two crystalline polyester polyols that are compositionally different and differ in molecular weight, at least two crystalline polyester polyols that exhibit different melting points, and combinations thereof.

Useful first crystalline polyester polyols include crystalline polyester polyols having a softening point of no greater than 120° C., no greater than 110° C., no greater than 100° C., or even no greater than 90° C., as measured according to ring and ball method ISO 4625. Suitable crystalline polyester polyols include, e.g., crystalline polyester polyols formed from a diol (e.g., an aliphatic diol having a carbon chain of at least 2 carbon atoms or a cycloaliphatic diol) and an aliphatic diacid. Examples of suitable aliphatic diols include 1,2-ethanediol, butane diols (e.g., 1,3-butanediol, 1,4-butanediol, and 1,2-butanediol), 1,5-pentanediol, 1,6-hexanediol, 1,8-octanediol, 1,10-decanediol, ethylene glycol, and combinations thereof. Examples of suitable cycloaliphatic diols include 1,4-cyclohexanediol and 1,4-cyclohexanedimethanol. Examples of suitable aliphatic diacids include adipic acid, 1,12-dodecanedioic acid, sebacic acid, terephthalic acid, succinic acid, glutaric acid, dimerized fatty acids, and combinations thereof.

Other suitable crystalline polyester polyols are formed from polycaprolactone and diol including, e.g., diethylene glycol, 1,4-butane diol, neopentyl glycol, 1,6-hexanediol, and combinations thereof.

Specific examples of suitable crystalline polyester polyols include poly(butanediol adipate) polyol, poly(hexanediol adipic acid terephthalate) polyol, poly(ethylene glycol dodecanoate) polyol, poly(cyclohexanedimethanol adipate) polyol, poly(butanediol succinate) polyol, and combinations thereof.

Suitable commercially available crystalline polyester polyols are sold under the DYNACOLL series of trade designations from Evonik Industries AG (Germany) including DYNACOLL 7321, 7330, 7340 and 7390, and the PIOTHANE series of trade designations from Panolam Industries Int'l, Inc. (Auburn, Me.) including, e.g., PIOTHANE 3500 ED ethylene glycol dodecanoate and PIOTHANE 2000CA cyclohexanedimethanol adipate.

The amount of crystalline polyester polyol used to form the polyurethane prepolymer is greater than 10% by weight, at least about 15% by weight, at least about 20% by weight, at least about 25% by weight, from about 15% by weight to about 50% by weight, from about 15% by weight to about 45% by weight, or even from about 15% by weight to about 40% by weight based on the weight of polyurethane prepolymer.

Polyisocyanate

Useful polyisocyanates include at least two isocyanate (—NCO) groups. Useful polyisocyanates include, e.g., aromatic, aliphatic, cycloaliphatic, arylalkyl, and alkylaryl, di-, tri-, and tetra-isocyanates, and mixtures thereof. Suitable polyisocyanates can be in a variety of forms including, e.g., monomers, oligomers, and mixtures thereof. Useful aromatic polyisocyanates include, e.g., diphenylmethane diisocyanate compounds (MDI) including its isomers (e.g., diphenylmethane 4,4′-diisocyanate, diphenylmethane-2,2′-diisocyanate, diphenylmethane-2,4′-diisocyanate, oligomeric methylene isocyanates having the formula

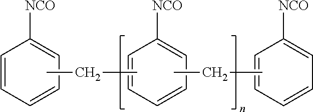

where n is an integer of from 0 to 5, and mixtures thereof), carbodiimide modified MDI, naphthalene diisocyanates including isomers thereof (e.g., 1,5-naphthalene diisocyanate (NDI)), isomers of triphenylmethane triisocyanate (e.g., triphenylmethane-4,4′,4″-triisocyanate), toluene diisocyanate compounds (TDI) including isomers thereof, 1,3-xylene diisocyanate (XDI), tetramethylxylene diisocyanate (TMXDI) (e.g., p-1,1,4,4-tetramethylxylene diisocyanate (p-TMXI) and m-1,1,3,3-tetramethylxylylene diisocyanate (m-TMXDI)), and mixtures thereof.

Useful aliphatic polyisocyanates include, e.g., hexamethylene diisocyanate (HDI), isophorone diisocyanate (IPDI), hydrogenated diphenylmethane diisocyanate, 1,6-diisocyanato-2,4,4-trimethylhexane, 1,4-cyclohexane diisocyanate (CHDI), 1,4-cyclohexanebis(methylene isocyanate) (BDI), 1,3-bis(isocyanatomethyl)cyclohexane (H₆XDI), dicyclohexylmethane diisocyanate (H₁₂ MDI), and mixtures thereof.

Useful polyisocyanates are commercially available under a variety of trade designations including, e.g., ISONATE 125M pure diphenylmethane diisocyanate (MDI), from Dow Chemical Co. (Midland, Mich.), MONDUR M from Bayer Chemicals (Pittsburgh, Pa.), ISONATE 50 OP and ISONATE 125M from Dow Chemical Company (Midland, Mich.), LUPRANATE M from BASF (Germany), and RUBINATE 1820 from Huntsman Advanced Materials America Inc. (Woodlands, Tex.).

Preferably the ratio of hydroxy groups to isocyanate groups in the composition used to form the polyurethane prepolymer is from about 0.2:1 to about 0.7:1, or even from about 0.3:1 to about 0.6:1, and the amount of polyisocyanate from which the polyurethane prepolymer is derived is from about 1% by weight to about 30% by weight, from about 5% by weight to about 25% by weight, or even from about 10% by weight to about 20% by weight.

Optional Polyether Polyol

The moisture curable hot melt adhesive composition optionally is also derived from polyether polyol. Polyether polyols suitable for the moisture curable hot melt adhesive composition have a number average molecular weight of from about 100 g/mol to about 8000 g/mol, from about 200 g/mol to about 4000 g/mol, or even from about 200 g/mol to about 1000 g/mol. Useful polyether polyols are derived from oxide monomers (e.g., ethylene oxide, propylene oxide, 1,2-butylene oxide, 1,4-butylene oxide, tetrahydrofuran, and combinations thereof) and a polyol initiator (e.g., ethylene glycol, propylene glycol, butanediols, hexanediols, glycerols, trimethylolethane, trimethylolpropane, and pentaerythritol, and combinations thereof). Suitable polyether polyols include, e.g., homopolymers of propylene oxide, ethylene oxide, and butylene oxide, copolymers of propylene oxide and ethylene oxide, copolymers of propylene oxide and butylene oxide, copolymers of butylene oxide and ethylene oxide, and mixtures thereof. Specific examples of suitable polyether polyols include, e.g., polyethylene glycol, polytetramethylene glycol, polypropylene glycol, polybutadiene glycol, and combinations thereof. The polyether polyol copolymers can have a variety of configurations including, e.g., random and block configurations.

Suitable commercially available polyether polyols are available under a variety of trade designations including, e.g., TERATHANE 1000 polyether glycol from Invista North America S.A.R.L. Corporation Luxembourg (Wichita, Kans.), ARCOL PPG-1000 polypropylene glycols and ACCLAIM Polyol 703 from Covestra (Pittsburgh, Pa.), and PolyG polypropylene glycols from Monument Chemical Kentucky LLC (Brandenburg, Ky.).

The moisture curable hot melt adhesive composition optionally is derived from about 0% by weight to no greater about 4% by weight, from about 0.1% by weight to about 3% by weight, or even from about 0.1% by weight to about 2% by weight polyether polyol.

Preparation of the Polyurethane Prepolymer

The polyurethane prepolymer can be prepared in any suitable manner including by reacting the polyols with the polyisocyanate at an elevated temperature of from greater than 60° C. to about 160° C. The polyol may first be introduced into a reaction vessel, heated to reaction temperatures and dried under vacuum to remove ambient moisture absorbed by the polyols. The polyisocyanate is then added to the reactor. The reaction between the polyols and the polyisocyanate is conducted at an OH:NCO ratio of from about 0.2:1 to about 0.7:1, or even from about 0.3:1 to about 0.6:1.

The polyurethane prepolymer, optionally formulated with a catalyst, polyisocyanate, and additional additives, is packaged in a suitable moisture proof container.

Catalyst

The moisture curable polyurethane hot melt adhesive composition optionally includes a catalyst to facilitate moisture cure. Useful catalysts include ether and morpholine functional groups, examples of which include 2,2′-dimorpholinoethylether, di(2,6-dimethyl morpholinoethyl)ether, and 4,4′-(oxydi-2,1-ethanediyl)bis-morpholine. Suitable commercially available catalysts include, e.g., JEFFCAT DMDEE 4,4′-(oxydi-2,1-ethanediyl)bis-morpholine, which is available from Huntsman Corp. (Houston, Tex.). A variety of metal catalysts are suitable including, e.g., catalysts based on tin (e.g. dibutyltin dilaurate and dibutyltin acetate), bismuth, zinc, and potassium.

The moisture curable hot melt adhesive composition optionally includes from about 0.01% by weight to about 2% by weight or even from about 0.05% by weight to about 1% by weight catalyst.

Polyisocyanate

The moisture curable polyurethane hot melt adhesive composition optionally includes polyisocyanate (e.g., from 0% by weight to 10% by weight or even from 0.1% by weight to 10% by weight polyisocyanate).

Additives

The moisture curable adhesive composition optionally includes a variety of additives including, e.g., thermoplastic polymer, tackifying agent, plasticizer, wax, stabilizer, antioxidant, fillers (talcs, clays, silicas and treated versions thereof, carbon blacks and micas, microparticles including, e.g., microspheres (e.g., glass microspheres, polymer microspheres, and combinations thereof), ultraviolet (UV) scavengers and absorbers, pigments (e.g., reactive or nonreactive oxides), fluorescing agents, odor masks, adhesion promoters (i.e., silane-based adhesion promoters), surfactants, defoamers, and combinations thereof.

Useful thermoplastic polymers include, e.g., ethylene vinyl acetate, ethylene vinyl acetate and vinyl alcohol copolymer, ethylene vinyl butyrate, ethylene acrylic acid, ethylene methacrylic acid, ethylene acrylamide copolymer, ethylene methacrylamide, acrylate copolymers (e.g., methyl acrylate, ethyl acrylate, methylmethacrylate, 2-ethylhexylacrylate, 2-ethylhexylmethacrylate, methoxyethylmethacrylate, methoxyethylacrylate, ethylene ethyl acrylate, ethylene n-butyl acrylate, and ethylene hydroxyethyl acrylate), ethylene n-butyl acrylate carbon-monoxide terpolymer, polyolefins (e.g., polypropylene and polyethylene), thermoplastic polyurethane, butylene/poly(alkylene ether) phthalate, thermoplastic polyester, and combinations thereof. The moisture curable adhesive composition optionally includes from about 0% by weight to no greater than 4% by weight or even from about 0.1% by weight to no greater than about 4% by weight thermoplastic polymer.

Useful tackifying agents include, e.g., aromatic, aliphatic, and cycloaliphatic hydrocarbon resins, mixed aromatic and aliphatic modified resins, aromatic modified hydrocarbon resins, and hydrogenated versions thereof; terpenes, modified terpenes, and hydrogenated versions thereof; rosin esters (e.g., glycerol rosin ester, pentaerythritol rosin ester, and hydrogenated versions thereof); and combinations thereof. Useful aromatic resins include, e.g., aromatic modified hydrocarbon resins, alpha-methyl styrene resin, styrene, polystyrene, coumorone, indene, and vinyl toluene, and styrenated terpene resin, polyphenols, polyterpenes, and combinations thereof. Useful aliphatic and cycloaliphatic petroleum hydrocarbon resins include, e.g., branched and unbranched C5 to C9 resins and the hydrogenated derivatives thereof. Useful polyterpene resins include copolymers and terpolymers of natural terpenes (e.g. styrene-terpene, alpha-methyl styrene-terpene, and vinyl toluene-terpene).

Useful waxes include, e.g., hydroxy modified waxes, carbon monoxide modified waxes, hydroxy stearamide waxes, fatty amide waxes, hydrocarbon waxes including, e.g., high density low molecular weight polyethylene waxes, paraffin waxes and microcrystalline waxes, and combinations thereof. The moisture curable adhesive composition optionally includes from about 0% by weight to about 3% by weight or even from about 0% by weight to about 1% by weight wax.

One useful class of stabilizers includes carbodiimide stabilizers (e.g., STABAXOL 7000 from Rhein Chemie (Germany).

Examples of useful commercially available antioxidants include IRGANOX 565, 1010 and 1076 hindered phenolic antioxidants available from Ciba-Geigy (Hawthorne, N.Y.), and ANOX 20 hindered phenolic antioxidant from Great Lakes Chemicals (West Lafayette, Ind.). These antioxidants can act as free radical scavengers and can be used alone or in combination with other antioxidants including, e.g., phosphite antioxidants (e.g., IRGAFOS 168 available from Ciba-Geigy). Other antioxidants include CYANOX LTDP thioether antioxidant available from Cytec Industries (Stamford, Conn.), and ETHANOX 330 a hindered phenolic antioxidant available from Albemarle (Baton Rouge, La.). The moisture curable polyurethane hot melt adhesive composition optionally includes no greater than about 2% by weight antioxidant.

Examples of useful commercially available fillers include MISTRON VAPOR talc from Luzenac America, Inc. (Englewood, Colo.). The moisture curable adhesive composition optionally includes less than about 10% by weight, no greater than about 5% by weight, or even no greater than about 2% by weight filler.

Examples of useful pigments include inorganic, organic, reactive, and nonreactive pigments, and combinations thereof.

The moisture curable adhesive composition can also optionally include organofunctional silane adhesion promoters. Preferred organofunctional silane adhesion promoters include silyl groups such as alkoxysilyls, aryloxysilyls, and combinations thereof. Examples of useful alkoxysilyl groups include methoxysilyl, ethoxysilyl, propoxysilyl, butoxysilyl, and acyloxysilyl reactive groups including, e.g., silyl ester of various acids including, e.g., acetic acid, 2-ethylhexanoic acid, palmitic acid, stearic acid, and oleic acid.

Suitable silane-based adhesion promoters include, e.g., epoxy glycidoxy propyl trimethoxy silane, octyltriethoxysilane, methyltrimethoxysilane, beta-(3,4-epoxy cyclohexyl)ethyl trimethoxy silane, methacryloxypropyl trimethoxy silane, alkyloxyiminosilyls, vinyl trimethoxy silane, vinyl triethoxy silane, vinyl methyl dimethoxy silane, amino propyl trimethoxy silane, amino propyl triethoxy silane, N-phenyl amino propyl trimethoxy silane, bis-(trimethoxy silyl propyl)amine, N-beta-(aminoethyl)-amino propyl trimethoxy silane, N-beta-(aminoethyl)-amino propyl trimethoxy silane, N-beta-(aminoethyl-amino propyl-methyl dimethoxy silane, ureido propyl trimethoxy silane, tris[3-(trimethoxysilyl) propyl] isocyanurate, 4-amino-3,3-dimethylbutyldimethoxymethylsilane, and ethoxy and methoxy/ethoxy versions thereof, mercaptopropyl trimethoxysilane, and mixtures thereof.

Suitable commercially available adhesion promoters are available under a variety of trade designations including, e.g., SILQUEST Y-11597, and SILQUEST A-189, A-187, A-174, A-186, A-171, A-172, A-2171, A-137, and A-162, all of which are available from Momentive Performance Materials (Waterford, N.Y.), and VPS 1146 and DAMO 1411, both of which are available from Degussa Corporation (Naperville, Ill.).

The moisture curable adhesive composition optionally includes from about 0.1% by weight to about 3% by weight, from about 0.1% to about 2% by weight, or even from about 0.2% to about 1.5% by weight adhesion promoter.

Use

The moisture curable adhesive composition can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The moisture curable adhesive composition can be applied as a continuous or discontinuous coating, in a single or multiple layers, and combinations thereof. The moisture curable adhesive composition can be applied at any suitable temperature including, e.g., from about 60° C. to about 200° C., from about 80° C. to about 175° C., or even from about 90° C. to about 120° C.

Optionally, the surface of the substrate on which the moisture curable adhesive composition is applied is surface treated to enhance adhesion using any suitable method for enhancing adhesion to the substrate surface including, e.g., corona treatments, chemical treatments (e.g., chemical etching), flame treatments, abrasion, and combinations thereof.

The moisture curable adhesive composition can be cured using a variety of mechanisms. The curing reaction occurs between a compound having an available active hydrogen atom and the NCO groups of the polyurethane prepolymer. A variety of reactive compounds having free active hydrogen(s) are known in the art including water, hydrogen sulfide, polyols, ammonia and other active compounds. These curing reactions may be carried out by relying on ambient moisture, the active compounds may be added to the composition at the bond line, the composition may be exposed to an active compound, and combinations thereof.

Article

The article can include a substrate having a variety of properties including rigidity (e.g., rigid substrates (i.e., the substrate cannot be bent by an individual using two hands or will break if an attempt is made to bend the substrate with two hands), flexibility (e.g., flexible substrates (i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

Useful substrate compositions include, e.g., polymer (e.g., polycarbonate, polyolefin (e.g., polypropylene, polyethylene, low density polyethylene, linear low density polyethylene, high density polyethylene, polypropylene, and oriented polypropylene, copolymers of polyolefins and other comonomers), polyether terephthalate, ethylene-vinyl acetate, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, cellulosics, polystyrene, and epoxy), polymer composites (e.g., composites of a polymer and metal, cellulose, glass, polymer, and combinations thereof), metal (aluminum, copper, zinc, lead, gold, silver, platinum, and magnesium, and metal alloys such as steel (e.g., stainless steel), tin, brass, and magnesium and aluminum alloys), carbon-fiber composite, other fiber-based composite, graphene, fillers, glass (e.g., alkali-aluminosilicate toughened glass and borosilicate glass), quartz, boron nitride, gallium nitride, sapphire, silicon, carbide, ceramic, and combinations thereof.

The substrates can be nonconductive or have any suitable conductivity including, e.g., a conductivity greater than 1×10⁶ siemens per meter.

The fillers can be in a variety of forms including, e.g., particles (spherical particles, beads, and elongated particles), fibers, and combinations thereof.

The substrate can be of a single material and a single layer or can include multiple layers of the same or different material. The layers can be continuous or discontinuous.

A variety of articles can include the adhesive composition including, e.g., clothing (e.g., jackets, coats, shirts, sweaters, pants, socks, belts, watches (e.g., watchbands), footwear (e.g., shoes and boots, e.g., ski boots), hand wear (e.g., gloves), head wear (e.g., hats, head bands, and ear muffs), neck wear (e.g., scarves), and combinations thereof. In some embodiments, the article is a piece of clothing that is intended to be worn by an individual and that includes a first substrate, the moisture cured polyurethane hot melt adhesive composition in contact with the first substrate, and optionally a second substrate bonded to the first substrate through the adhesive composition.

The adhesive composition is useful in a variety of electronic devices including, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, appliances (e.g., refrigerators, washing machines, dryers, ovens, and microwaves), light bulbs (e.g., incandescent, light emitting diode, and fluorescent), and articles that include a visible transparent or transparent component, glass housing structures, protective transparent coverings for a display or other optical component.

In some embodiments, the article 40 includes a first substrate 30 bonded to an electrically conductive element 34 through the moisture cured adhesive composition 20 and a second substrate 32 bonded to the electrically conductive element 34 and the first substrate 30 through the moisture cured adhesive composition 20, as shown in FIG. 2.

In other embodiments, the article 50 is in the form of a wearable electronic device that includes a first fabric 52, a second fabric 54, and a moisture cured adhesive composition 20 disposed between the first fabric 52 and the second fabric 54, as shown in FIG. 3. The first fabric 52 is bonded to the second fabric 54 through the adhesive composition 20. An electrical component 60 is also disposed between the first fabric 52 and the second fabric 54 and maintained in a fixed position relative to the first and second fabrics 52 and 54 through the adhesive composition 20. The electrical component 60 is in the form of a flexible ribbon that includes a first polymer film 62 and second polymer film 64 and a conductive circuit 66 disposed between the first film 62 and the second film 64.

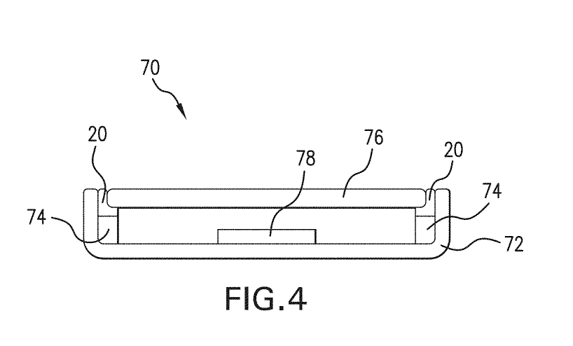

In other embodiments, the article 70 is in the form of a hand held electronic device that includes a housing 72, a frame 74, a moisture cured adhesive composition 20, a display 76 bonded to the frame 74 through the adhesive composition 20, and electrical components 78 mounted between the housing 72 and the display 76, as shown in FIG. 4. In some embodiments, the frame 72 is metal (e.g., aluminum) and the display 76 is glass.

The invention will now be described by way of the following examples. All parts, ratios, percentages and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Viscosity Test Method

Viscosity is determined at 120° C. using a Brookfield Thermosel viscometer and a spindle number 27.

### Melt Transition Test Method

The presence of a melt transition is determined using Differential Scanning Calorimetry according to the following process. The sample is equilibrated to 25° C., heated to 120° C. at a rate of 200° C./min, held at 120° C. for ten minutes, cooled from 120° C. to −40° C. at a rate of 5° C./min, held at −40° C. for ten minutes and then heated from −40° C. to 120° C. at 5° C./min. The presence of an endothermic peak during the second heating step, i.e., during the heating from −40° C. to 120° C., reflects the presence of a melt transition. The peak value of the endothermic peak is recorded as the melting point (Tm).

### Open Time Test Method

A sample of adhesive composition is preheated in an oven to 120° C. A 10 inch (in) by 4 in by 0.002 in polyester (PET) film is placed on a 0.003 in release paper carrier film. Two mL of the heated sample of adhesive composition is applied in a thin bead to the PET film. The release paper carrier film, PET film, and adhesive are then drawn between two round stainless steel bars that have been heated to 120° C. and that are separated at a distance of 0.010 in to produce an adhesive film having a thickness of 0.005 in. The adhesive coated PET film is then placed with the adhesive surface face up on a sheet of corrugated cardboard and a timer is immediately started. Craft paper strips are pressed into the adhesive at various time intervals until the adhesive loses tack as determined by touching it with a finger. After the adhesive is tack free, the paper strips are peeled away from the adhesive and the surface of the adhesive composition is observed. The percentage of the surface area of the adhesive composition that is covered by paper or fibers is determined and recorded. The adhesive is considered “closed” after the time at which less than 90% fiber tear is observed. The open time is the time during which at least 90% fiber tear is observed. An adhesive that exhibits at least 90% fiber tear at 40 seconds, but less than 90% fiber tear at 60 seconds, for example, is deemed to have an open time of 40 seconds.

### Glass Transition (T_{g}) Test Method

The glass transition temperature is determined using Differential Scanning Calorimetry according to the following process. The sample is equilibrated to 25° C., heated to 120° C. at a rate of 200° C. per minute (° C./min), held at 120° C. for ten minutes, cooled from 120° C. to −65° C. at a rate of 60° C./min, held at −65° C. for 10 minutes, and then heated from −65° C. to 120° C. at a rate of 20° C./min. The presence of a step increase in heat flow during the heating from −65° C. to 120° C. indicates that the glass transition has occurred. The glass transition temperature is defined as the temperature at which the heat flow is at the midpoint of the step change.

### Test Sample Preparation Method

Polycarbonate to Polycarbonate Test Sample Preparation Method

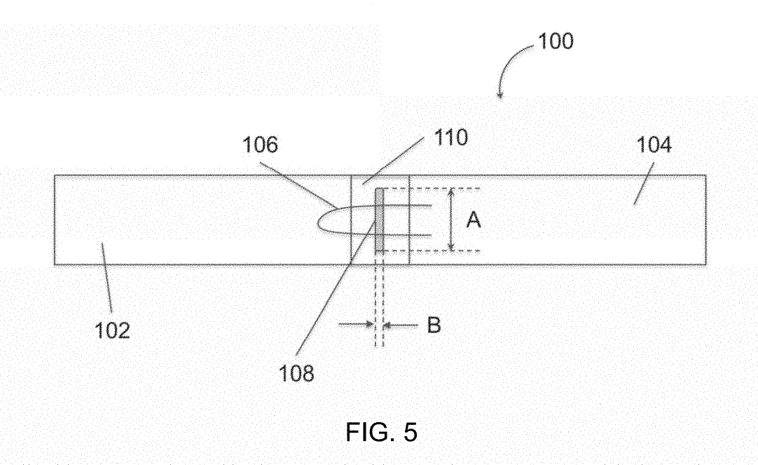

Each test specimen (100) is constructed from two clear polycarbonate plaques (102, 104) (25.4 mm in width, 101.6 mm in length, 3.18 mm in thickness), a single stainless steel wire 75 microns in thickness (106), and a small amount of the adhesive composition (108) as shown in FIG. 5. The plaques (102, 104) are cleaned with isopropyl alcohol and the 75 micron stainless steel wire (106) is secured on the first polycarbonate plaque (102) using clear plastic tape (not shown). Next a very small amount of the adhesive composition (108) is dispensed on the second polycarbonate plaque (104) using a high precision adhesive dispensing robot. The second plaque (104) is then positioned on the first plaque (102) such that the first plaque (102) and the second plaque (104) overlap (110) with each other 12.7 mm and the bead of adhesive composition (108) is centered in the overlap area (110), and then pressure is applied to the second plaque (104) in the center of the overlap using a 1 kg weight until the adhesive composition (108) has solidified. The clear plastic tape mentioned above is outside of both the area of the adhesive composition and the area of overlap (110) of the two plaques (102, 104).

The amount and shape of the dispensed adhesive composition is precisely adjusted so that the shape of the adhesive bead area after pressing is exactly 20+/−0.1 mm in length (A), 2.0 mm+/−0.1 mm in width (B), and 75 microns in thickness. Test specimens that do not meet the strict bond area criterion are rejected.

Polycarbonate to Stainless Steel Test Sample Preparation Method

Each test specimen is constructed as described above with respect to the Polycarbonate to Polycarbonate Test Sample Preparation Method with the exception that the substrates are a polycarbonate plaque and a stainless steel plaque instead of two polycarbonate plaques and the first substrate referred to in the method is the polycarbonate plaque and the second substrate referred to in the method is the stainless steel plaque.

### Bond Strength Test Method

The bond strength of a test sample is tested according to ASTM test method D1002 entitled, “Standard Test Method for Apparent Sheer Strength of Single Lamp Joint Adhesively Bonded Metal Specimens by Tension Loading (Metal To Metal),” with the exception that the test samples are prepared according to one of the above described Test Sample Preparation Methods. The cross-head speed is 50 mm/min. A minimum of 10 samples are tested to obtain a statistically significant result. The maximum load, in units of Pounds of Force (lbf), is recorded and reported as the bond strength to polycarbonate for test samples that include two polycarbonate plaques and as the bond strength to stainless steel for test samples that include a polycarbonate plaque bonded to a stainless steel plaque.

### Chemical Resistance Test Method

Polycarbonate to Polycarbonate Chemical Resistance Test Method

A test sample is prepared according to the Polycarbonate to Polycarbonate Test Sample Preparation Method and then coated with a chemical. The chemical is applied using a transfer pipet along the edges of the overlap bond such that capillary action draws the chemical to the center of the sample. The chemical should completely fill any empty space around the adhesive bead. The sample is then aged at 65° C. and 90% relative humidity for a period of 48 hours. The sample is then brought to room temperature and held at 25° C. and 50% relative humidity for a period of about 24 hours. The sample is then tested according to the Bond Strength Test Method. The maximum force is measured in the shear mode and the results are reported in units of Pounds of Force (lbf). A minimum of 10 samples are tested to obtain a statistically significant result.

Polycarbonate to Stainless Steel Chemical Resistance Test Method

The test method is the same as the Polycarbonate to Polycarbonate Chemical Resistance Test Method with the exception that the test sample is prepared according to the Polycarbonate to Stainless Steel Test Sample Preparation Method.

### Oleic Acid Resistance Test Method

Polycarbonate to Polycarbonate Oleic Acid Resistance Test Method

A sample is prepared and tested according to the Polycarbonate to Polycarbonate Chemical Resistance Test Method with the exception that the chemical used is oleic acid having greater than 70% purity.

Polycarbonate to Stainless Steel Oleic Acid Resistance Test Method

A sample is prepared and tested according to the Polycarbonate to Stainless Steel Chemical Resistance Test Method with the exception that the chemical used is oleic acid having greater than 70% purity.

### Method of Determining Percentage of Retention of Bond Strength to Polycarbonate

The percentage of retention of bond strength to polycarbonate is determined according to the following method. A number of test samples are prepared according to the Polycarbonate to Polycarbonate Test Sample Preparation Method. A first one of the test samples is tested according to the Bond Strength Test Method and the result is recorded as Si. A second one of the test samples is then tested according the Oleic Acid Resistance Test Method and the result is recorded as So. The percentage of retained bond strength (%) is calculated according to the following equation:

%=[So/Si]*100

and the result is reported as % retention of bond strength to polycarbonate.

### Method of Determining Percentage of Retention of Bond Strength to Stainless Steel

The percentage of retention of bond strength to stainless steel is determined according to the Method of Determining Percentage of Retention of Bond Strength to Polycarbonate with the exception that the test samples are prepared according to the Polycarbonate to Stainless Steel Test Sample Preparation Method and the result is reported as % retention of bond strength to stainless steel.

### Solubility Parameter Calculation Method

A solubility parameter (δ) is calculated according to the method described by Michael M. Coleman, John F. Graf and Paul C. Painter in their book entitled, “Specific interactions and the miscibility of polymer blends,” Technomic Publishing AG, (Lancaster, Pa. (1991)). Two factors are assigned to each functional group (i) contained in the polymer (e.g. where i represents a “—CH₂—” “methylene” unit, a “—CH₃” “methyl” group, or a “—O—C—O—” ester group). The factors are: 1) molar volume constant (Vᵢ*[=] cm³mol⁻¹), and 2) molar attraction constant (Fᵢ*[=] cal^{1/2}cm^{3/2}mol⁻¹). These values are obtained from the tabulated set of values in Tables 2.2A and 2.5 on pages 59 and 68, respectively, of the aforementioned book entitled, “Specific interactions and the miscibility of polymer blends.” The number (nᵢ) of each functional group (i) is also determined. The solubility parameter is calculated using the equation:

$$δ = \frac{{\sum }_{i} {n}_{i} {F}_{i}^{*}}{{\sum }_{i} {n}_{i} {V}_{i}^{*}}$$

where nᵢ, Fᵢ* and Vᵢ* are as set forth above.

### Samples C1-C3 and Examples E1-E6

Samples C1-C3 and Examples E1-E6 were prepared as follows: amorphous polyester polyol and crystalline polyester polyol of the types and in the amounts set forth in Table 1 (in % by weight) were loaded into a glass reactor along with MODAFLOW flow agent (Monsanto Chemical Company Corporation, St. Louis, Mo.). The mixture was dried under vacuum at 120° C. for 90 minutes. Then diphenylmethane 4,4′-diisocyanate (4,4′-MDI) was slowly added to the mixture (in the amount specified in Table 1 (in % by weight)) under a nitrogen blanket with vigorous stirring. After the isocyanate addition, the reaction was allowed to proceed at 120° C. under vacuum for 75 minutes or until a free isocyanate target of 3% was achieved. The 2,2′-dimorpholinoethylether catalyst (DMDEE) was then added to the mixture under nitrogen blanket. After mixing for 10 minutes under vacuum, the formulation was discharged from the reactor and then stored in tin cans under nitrogen purge.

Test samples were prepared according to according to the Test Sample Preparation Method and tested according to the Strength test method and the Oil Resistance test method using 213 NF oleic acid having a purity of greater than 70% (Parchem Trading Ltd., New Rochelle, N.Y.). The results are reported in Table 1.

TABLE 1

| Example | Tm | δ | C1 | C2 | C3 | E1 | E2 | E3 | E4 | E5 | E6 |
|---|---|---|---|---|---|---|---|---|---|---|---|
| Hexane diol adipate | 63 | 9.37 | 20.47 | 0 | 28 | 0 | 0 | 0 | 0 | 0 | 0 |
| polyester diol¹ | | | | | | | | | | | |
| Ethylene glycol | 85 | 9.21 | 0 | 0 | 0 | 0 | 20 | 0 | 20 | 0 | 0 |
| dodecanoate polyester | | | | | | | | | | | |
| polyol² | | | | | | | | | | | |
| Cyclohexanedimethanol | 105 | 9.65 | 0 | 0 | 0 | 0 | 10 | 0 | 0 | 0 | 0 |
| adipate³ | | | | | | | | | | | |
| Cyclohexanedimethanol | 105 | 9.65 | 0 | 0 | 0 | 0 | 0 | 0 | 0 | 0 | 30 |
| adipate⁴ | | | | | | | | | | | |
| Butanediol succinate | 118 | 10.03 | 0 | 30 | 0 | 30 | 0 | 20 | 0 | 28 | 0 |
| polyester polyol⁵ | | | | | | | | | | | |
| Hexanediol phthalate⁶ | NA | 10.26 | 61.42 | 0 | 0 | 51.15 | 50.84 | 60.87 | 60.87 | 0 | 51.34 |
| Hexanediol phthalate⁷ | NA | 10.26 | 0 | 0 | 56.17 | 0 | 0 | 0 | 0 | 56.17 | 0 |
| Adipic acid copolyester | NA | 9.66 | 0 | 55.24 | 0 | 0 | 0 | 0 | 0 | 0 | 0 |
| with ethylene glycol, | | | | | | | | | | | |
| neopentyl glycol, and | | | | | | | | | | | |
| hexanediol⁸ | | | | | | | | | | | |
| Methylene | NA | NA | 18.08 | 13.5 | 14.52 | 17.34 | 17.9 | 17.87 | 17.87 | 14.52 | 17.4 |
| bis(isocyanatobenzene) | | | | | | | | | | | |
| Mercaptopropyletri- | NA | NA | 0 | 1 | 1 | 1 | 1 | 1 | 1 | 1 | 1 |
| methoxysilane⁹ | | | | | | | | | | | |
| Dimorpholinodiethylether | NA | NA | 0.03 | 0.25 | 0.25 | 0.25 | 0.25 | 0.25 | 0.25 | 0.25 | 0.25 |
| Polyethersiloxane | NA | NA | 0 | 0.01 | 0.01 | 0.01 | 0.01 | 0.01 | 0.01 | 0.01 | 0.01 |
| Overlap Shear (lbf) | | | | | | | | | | | |
| PC/PC: Control | | | 115 | NT | 88 | 150 | 125 | NT | NT | 126 | 121 |
| PC/PC: Oleic Acid | | | 42 | NT | 3 | 150 | 130 | NT | NT | 172 | 179 |
| % Retention | | | 37 | NT | 3.4 | 100 | 104 | NT | NT | 137 | 148 |
| PC/SS: Control | | | NT | 80 | 74 | 70 | 70 | 96 | 91 | 76 | 58 |
| PC/SS: Oleic Acid | | | NT | 2 | 6.6 | 50 | 40 | 59 | 51 | 52 | 37 |
| % Retention | | | NT | 2.5 | 8.9 | 71.4 | 57 | 61 | 56 | 68 | 64 |

Tm = melting point in units of ° C.
δ = solubility parameter in units of (cal/cm³)^{1/2}
¹PIOTHANE 3500 HA hexanediol adipate crystalline polyester polyol having a number average molecular weight of 3500 g/mol (Panolam Industries Int'l, Inc., Auburn, Maine)
²PIOTHANE 3500 ED ethylene glycol dodecanoate polyester polyol having a number average molecular weight of 3500 g/mol (Panolam Industries Int'l)
³PIOTHANE 2000 CA cyclohexanedimethanol adipate polyester polyol having a number average molecular weight of 2000 g/mol (Panolam Industries Int'l)
⁴PIOTHANE 3500 CA cyclohexanedimethanol adipate polyester polyol having a number average molecular weight of 3500 g/mol (Panolam Industries Int'l)
⁵DYNACOLL 7390 crystalline polyester polyol having a number average molecular weight of 3500 g/mol (Evonik Industries AG, Germany)
⁶PIOTHANE 2000 HP hexanediol phthalate polyester polyol having a number average molecular weight of 2000 g/mol and a T_{g} of −19 ° C. (Panolam Industries Int'l)
⁷PIOTHANE 3500 HP hexanediol phthalate polyester polyol having a number average molecular weight of 3500 g/mol and a T_{g} of −18 ° C. (Panolam Industries Int'l)
⁸DYNACOLL 7250 amorphous polyester polyol having a number average molecular weight of 3500 g/mol (Evonik Industries)
⁹SILQUEST A189 (Momentive Performance Materials, Waterford, New York)

### Electronic Device 1

Electronic Device 1 is prepared by applying the moisture curable adhesive composition of Example E1 of Table 1 to the metal edge of a housing that houses electronic circuitry. Within two minutes the adhesive composition is contacted with the edges of a glass display. The adhesive composition is allowed to cure to form a handheld electronic device. The adhesive bond is expected to be maintained after repeated handling of the device by a user.

### Electronic Device 2

Electronic Device 2 is prepared according to the preparation of Electronic Device 1 with the exception that the moisture curable adhesive composition is the adhesive composition of E2 instead of E1. The adhesive bond is expected to be maintained after repeated handling of the device by a user.

### Electronic Device 3

Electronic Device 3 is prepared according to the preparation of Electronic Device 1 with the exception that the moisture curable adhesive composition is the adhesive composition of E3 instead of E1. The adhesive bond is expected to be maintained after repeated handling of the device by a user.

### Electronic Device 4

Electronic Device 4 is prepared according to the preparation of Electronic Device 1 with the exception that the moisture curable adhesive composition is the adhesive composition of E4 instead of E1. The adhesive bond is expected to be maintained after repeated handling of the device by a user.

Other embodiments are within the claims.

References referred to herein are hereby incorporated herein to the extent they do not conflict.

1. A moisture curable polyurethane hot melt adhesive composition comprising: a polyurethane prepolymer comprising the reaction product of an amorphous polyester polyol having a solubility parameter of at least 9.8 (calories per cubic centimeter)^{1/2}, and a glass transition temperature (Tg) of no greater than 25° C., at least 10% by weight of a crystalline polyester polyol having a melting point of at least 75° C., from 0% by weight to no greater than 10% by weight of a crystalline polyester polyol having a melting point of less than 70° C., and polyisocyanate.

2. A moisture curable polyurethane hot melt adhesive composition comprising: a polyurethane prepolymer comprising the reaction product of an amorphous polyester polyol having a solubility parameter of at least 9.8 (calories per cubic centimeter)^{1/2}, and a glass transition temperature (Tg) of no greater than 25° C., at least 20% by weight of a crystalline polyester polyol having a melting point of at least 75° C. and a molecular weight from about 1000 grams per mole (g/mol) to no greater than 20,000 g/mol, and polyisocyanate.

3. A moisture curable polyurethane hot melt adhesive composition comprising: a polyurethane prepolymer comprising the reaction product of an amorphous polyester polyol having a solubility parameter of at least 9.8 (calories per cubic centimeter)^{1/2}, and a glass transition temperature (Tg) of no greater than 25° C., at least 10% by weight of a crystalline polyester polyol having a melt temperature of at least 75° C., and polyisocyanate, the composition exhibiting at least 30% retention of bond strength to stainless steel when tested according to the Method of Determining Percentage of Retention of Bond Strength to Stainless Steel.

4. The composition of any one of paragraphs 1-3, wherein the amorphous polyester polyol comprises hexanediol phthalate polyester diol.

5. The composition of any one of paragraphs 1-4, wherein the crystalline polyester polyol having a melting point of at least 75° C. comprises ethylene glycol dodecanoate polyester polyol, cyclohexanedimethanol adipate polyester polyol, butanediol succinate polyester polyol, or a combination thereof.

6. The composition of any one of paragraphs 1-5, wherein the amorphous polyester polyol has a solubility parameter of at least 10.0 (cal/cm³)^{1/2}.

7. The composition of any one of paragraphs 1-5, wherein the amorphous polyester polyol has a solubility parameter of at least 10.2 (cal/cm³)^{1/2}.

8. The composition of any one of paragraphs 1-7, wherein the crystalline polyester polyol having a melting point of at least 75° C. comprises at least two different crystalline polyester polyols each having a melting point of at least 75° C.

9. The composition of claim 8, wherein the melting point of one of the at least two different crystalline polyester polyols is greater than the melting point of another of the at least two different crystalline polyester polyols.

10. The composition of any one of paragraphs 1-9, wherein the polyurethane prepolymer comprises the reaction product of at least 20% by weight of the amorphous polyester polyol and at least 15% by weight crystalline polyester polyol having a melting point of at least 75° C.

11. The composition of any one of paragraphs 1-10, wherein the polyurethane prepolymer comprises the reaction product of at least 40% by weight of the amorphous polyester polyol and at least 15% by weight crystalline polyester polyol having a melting point of at least 75° C.

12. The composition of any one of paragraphs 1-11, wherein the amorphous polyester polyol has a Tg of no greater than 20° C.

13. The composition of any one of paragraphs 1-11, wherein the amorphous polyester polyol has a Tg of no greater than 0° C.

14. The composition of any one of paragraphs 1-13, wherein the composition exhibits a viscosity of less than 10,000 centipoises at 120° C.

15. The composition of any one of paragraphs 1-14, wherein the composition exhibits an open time of at least 50 seconds.

16. The composition of any one of paragraphs 1-15, wherein the composition exhibits at least 80 pounds of force (lbf) when tested according to the Polycarbonate to Polycarbonate Oleic Acid Resistance Test Method.

17. The composition of any one of paragraphs 1-16, wherein the composition exhibits at least 30 lbf when tested according to the Polycarbonate to Stainless Steel Oleic Acid Resistance Test Method.

18. The composition of any one of paragraphs 1-16, wherein the composition exhibits at least 40 lbf when tested according to the Polycarbonate to Stainless Steel Oleic Acid Resistance Test Method.

19. The composition of any one of paragraphs 1-18, wherein the composition exhibits at least 50% a retention of bond strength to polycarbonate.

20. The composition of any one of paragraphs 1-19, wherein the composition exhibits at least 30% retention of bond strength to stainless steel.

21. An article comprising: a first substrate; a moisture cured polyurethane hot melt adhesive composition; and a second substrate bonded to the first substrate through the cured adhesive composition, the cured adhesive composition having been derived from the moisture curable composition of any one of paragraphs 1-20.

22. The article of paragraph 21 further comprising an electrically conductive element.

23. The article of any one of paragraphs 21 and 22, wherein the article is a wearable electronic device and when the device is worn by an individual as intended the adhesive composition contacts at least one of the skin of the individual and a fluid emitted by the individual.

24. The article of any one of paragraphs 21-23, wherein the article is a hand held electronic device and when the device is held by an individual the adhesive composition contacts at least one of the skin of the individual and a fluid emitted by the individual.

25. The article of any one of paragraphs 21-24, wherein the first substrate comprises at least a portion of a watch band, at least a portion of a pump for dispensing medicine, at least a portion of a headband or a combination thereof.

26. The article of any one of paragraphs 21-25, wherein the article comprises an electronic monitor.

27. The article of any one of paragraphs 21-26, wherein the article comprises eye glasses.

28. The article of any one of paragraphs 21-27, wherein the article comprises a phone, a tablet, a sound player, a remote control, a mouse, or a combination thereof.

29. The article of any one of paragraphs 21-28, wherein the first substrate comprises polymer, polymer composite, metal, fabric, or a combination thereof, and the second substrate comprises polymer, polymer composite, metal, fabric, or a combination thereof.

30. The article of any one of paragraphs 21-28, wherein the first substrate comprises fabric, film, or a combination thereof and the second substrate comprises fabric, film, or a combination thereof.

31. The article of any one of paragraphs 21-30 further comprising a third substrate, the first substrate, the second substrate, and the third substrate being bonded to one another through the cured adhesive composition.

32. The article of any one of paragraphs 22-31, wherein the electrically conductive element comprises metal.

33. The article of any one of paragraphs 22-35, wherein the electrically conductive element comprises an electrically conductive polymer.

What is claimed is:

1. A moisture curable polyurethane hot melt adhesive composition comprising:
a polyurethane prepolymer comprising the reaction product of
an amorphous polyester polyol having a solubility parameter of at least 9.8 (calories per cubic centimeter)^{1/2}, and a glass transition temperature of no greater than 25° C.,
at least 10% by weight of a crystalline polyester polyol having a melting point of at least 75° C.,
from 0% by weight to no greater than 10% by weight of a crystalline polyester polyol having a melting point of less than 70° C., and
polyisocyanate.

2. The composition of claim 1, wherein the crystalline polyester polyol has a melting point of at least 75° C. comprises ethylene glycol dodecanoate polyester polyol, cyclohexanedimethanol adipate polyester polyol, butanediol succinate polyester polyol, or a combination thereof.

3. The composition of claim 1, wherein the amorphous polyester polyol has a solubility parameter of at least 10.0 (cal/cm³)^{1/2}.

4. The composition of claim 1, wherein the crystalline polyester polyol has a melting point of at least 75° C. and comprises at least two different crystalline polyester polyols each at least two different crystalline polyester having a melting point of at least 75° C.

5. The composition of claim 4, wherein the melting point of one of the at least two different crystalline polyester polyols is greater than the melting point of another of the at least two different crystalline polyester polyols.

6. The composition of claim 1, wherein the polyurethane prepolymer comprises the reaction product of
at least 20% by weight of the amorphous polyester polyol and
at least 15% by weight of the crystalline polyester polyol having a melting point of at least 75° C.

7. The composition of claim 1, wherein the polyurethane prepolymer comprises the reaction product of
at least 40% by weight of the amorphous polyester polyol, and
at least 15% by weight crystalline polyester polyol having a melting point of at least 75° C.

8. The composition of claim 1, wherein the amorphous polyester polyol has a Tg of no greater than 20° C.

9. The composition of claim 1, wherein the amorphous polyester polyol has a Tg of no greater than 0° C.

10. The composition of claim 1, wherein the composition exhibits a viscosity of less than 10,000 centipoises at 120° C.

11. The composition of claim 1, wherein the amorphous polyester polyol comprises hexanediol phthalate polyester diol.

12. The composition of claim 1, wherein the composition exhibits at least 80 pounds of force (lbf) when tested according to the Polycarbonate to Polycarbonate Oleic Acid Resistance Test Method.

13. The composition of claim 1, wherein the composition exhibits at least 30 lbf when tested according to the Polycarbonate to Stainless Steel Oleic Acid Resistance Test Method.

14. The composition of claim 1, wherein the composition exhibits at least 50% a retention of bond strength to polycarbonate.

15. The composition of claim 1, wherein the composition exhibits an open time of at least 50 seconds.

16. A moisture curable polyurethane hot melt adhesive composition comprising:
a polyurethane prepolymer comprising the reaction product of
an amorphous polyester polyol having a solubility parameter of at least 9.8 (calories per cubic centimeter)^{1/2}, and a glass transition temperature of no greater than 25° C.,
at least 10% by weight of a crystalline polyester polyol having a melting point of at least 75° C., and
polyisocyanate,
the composition exhibiting at least 30% retention of bond strength to stainless steel.

17. A moisture curable polyurethane hot melt adhesive composition comprising:
a polyurethane prepolymer comprising the reaction product of
an amorphous polyester polyol having a solubility parameter of at least 9.8 (calories per cubic centimeter)^{1/2}, and a glass transition temperature of no greater than 25° C.,
at least 20% by weight of a crystalline polyester polyol having a melting point of at least 75° C. and a molecular weight from about 1000 grams per mole (g/mol) to no greater than 20,000 g/mol, and polyisocyanate.

18. An article comprising:
a first substrate;
a moisture cured polyurethane hot melt adhesive composition; and
a second substrate bonded to the first substrate through the cured adhesive composition, the cured adhesive composition comprising having been derived from the moisture curable composition of claim 1.

19. The article of claim 18, wherein
the first substrate comprises polymer, polymer composite, metal, fabric, or a combination thereof, and
the second substrate comprises polymer, polymer composite, metal, fabric, or a combination thereof, and
the article further comprises an electrically conductive element comprising metal, an electrically conductive polymer, or a combination thereof.

20. The article of claim 19, wherein the article comprises a wearable electronic device, hand held electronic device, eye glasses, a phone, a tablet, a sound player, a remote control device, a mouse, a watch band, a pump for dispensing medicine, a headband, or a combination thereof.
